(19) United States
(12) Patent Application Publication
(10) Pub. No.: US 2023/0132673 A1
(43) Pub. Date: May 4, 2023

(54) METHOD AND SYSTEM FOR PRESENTING DRIVER PERFORMANCE METRICS ON A USER INTERFACE

(71) Applicant: BLUEOWL, LLC, San Francisco, CA (US)

(72) Inventors: Micah Wind Russo, Oakland, CA (US); Theobolt N. Leung, San Francisco, CA (US); Gareth Finucane, San Francisco, CA (US); Eric Dahl, Newman Lake, WA (US)

(21) Appl. No.: 16/203,894

(22) Filed: Nov. 29, 2018

(51) Int. Cl. G07C 5/06; G06Q 40/08; G07C 5/00

(52) U.S. Cl. CPC G07C 5/06; G06Q 40/08; G07C 5/008; G06F 3/0484

(57) ABSTRACT

A method and system may present indications of driver performance metrics on a user interface of a client device based on vehicle data for a user collected over a time interval. The driver performance metrics may include scores for each of several telemetry factors, such as braking, speeding, acceleration, and maneuvers. The user interface may also include indications of levels of safe driving behavior and corresponding driver performance metric ranges for reaching such levels. The indications of the driver performance metrics for the user may be placed in respective positions within the driver performance metric ranges. When the user reaches one of the levels of safe driving behavior based on the driver performance metrics, the user may be provided with a benefit corresponding to the level.

### TECHNICAL FIELD

The present disclosure generally relates to presenting driver performance metrics and, more particularly to analyzing telemetry factors from a user's vehicle data and providing a display including the user's driver performance metrics for each of the telemetry factors.

### BACKGROUND

Today, while drivers may be aware that unsafe driving habits, such as harsh braking or excessive speeding can be harmful to their vehicles and/or increases the likelihood of a collision, drivers have a difficult time quantifying their increased risk from these habits. Furthermore, telematics data is collected at vehicles including various characteristics of the vehicles, such as their location, speed, acceleration, etc. However, the telematics data is not presented in such a way for drivers to recognize the areas in which they need the most improvement, or in a way that incentivizes drivers to reduce their unsafe driving habits and provides simple suggestions for the drivers to make significant improvements.

### SUMMARY

To present vehicle data in a manner that improves the efficiency of using a client device, a driver performance system determines a metric for each of several telemetry factors, such as braking, acceleration, speeding, maneuvers, etc., based on the number of unsafe driving events or the amount of time in which the unsafe driving events occurred over a particular time interval. For example, a braking metric may be a score from one to one hundred based on the number of times the driver performed a sudden stop having a force exceeding a threshold value (e.g., 0.4 G) within the past month or 30 days. In another example, a speeding metric may be a score from one to one hundred based on the amount of time in which the driver exceeded a threshold speed (e.g., 80 miles per hour) within the past month or 30 days. In yet another example, an acceleration metric may be a score from one to one hundred based on the number of times the driver accelerated above a threshold (e.g., 0.3 G) within the past month or 30 days. Moreover, in yet another example, a maneuvering metric may be a score from one to one hundred based on the number of times the driver performed a hard maneuver, turning with a cornering force exceeding a threshold value (e.g., 0.2 G) within the past month or 30 days.

The driver performance system presents indications of the metrics on a driving summary display for review by the user for each of the telemetry factors. For each telemetry factor, the driving summary display includes an indication of a range of driver performance metrics (e.g., a score between 70 and 80) that corresponds to a particular level of safe driving behavior. The indications of driver performance metrics for the user are presented within the respective driver performance metric ranges. The driver performance system also determines whether the user has reached one of the levels of safe driving behavior based on an analysis of the user's driver performance metrics over time. When the driver performance system determines that the user has reached a particular level, the user qualifies for a type of benefit corresponding to the particular level, such as a vehicle care benefit or an accident forgiveness benefit. More specifically, a first level of safe driving behavior may be a star level that corresponds to vehicle care benefits. Accordingly, the driving summary display may present a graphic depiction of a star above ranges of scores for each of the telemetry factors which correspond to the star level. The graphic depiction of the star may have a fill level that corresponds to the amount remaining until the user reaches the star level and is eligible to receive a vehicle care benefit. The fill level may increase as the driving performance metrics for one or more of the telemetry factors reach the range corresponding to the star level, stay in the range over a threshold time period, or exceed the range.

A second level of safe driving behavior may be a shield level that corresponds to accident forgiveness benefits. Accordingly, the driving summary display may present a graphic depiction of a shield above ranges of scores for each of the telemetry factors which correspond to the shield level. The graphic depiction of the star may have a fill level that corresponds to the amount remaining until the user reaches the shield level and is eligible to receive an accident forgiveness benefit. The fill level may increase as driving performance metrics one or more of the telemetry factors reach the range corresponding to the shield level, stay in the range over a threshold time period, or exceed the range.

When the fill level for one of the levels of safe driving behavior meets or exceeds a threshold value (e.g., 95 percent, 100 percent, etc.), the user is provided with the benefit corresponding to the level. For example, the user may be provided with a star which can be redeemed for a free car wash or a shield which can be redeemed for a deductible credit. Rather than redeeming the stars or shields right away, the user can save them until she collects multiple stars or shields which may be redeemed for additional benefits.

In this manner, the user is presented with a simple, comprehensible overview of his performance on the road as well as ways in which he may improve to earn various benefits. For example, if the driving summary display includes a braking metric indicator that is below the range corresponding to the star level and a speeding metric indicator that is within the range corresponding to the shield level, the user can easily recognize that he needs to improve his braking and is travelling at safe speeds. The present embodiments advantageously provide a user interface that presents complicated telematics data in a manner that is easily understandable by a user. In comparison to alternative systems where raw telematics data is provided or the user is simply made aware that the telematics data is being analyzed without reporting the results to the user, the present embodiments allow the user to recognize where he needs to improve the most, and where he needs to remain consistent to qualify for various benefits.

In an embodiment, a method for presenting driver performance metrics on a user interface is provided. The method includes determining one or more driver performance metrics for one or more telemetry factors based on vehicle data for a user collected over a time interval. The method further includes presenting a driving summary display indicative of driver performance for each of the one or more telemetry factors, the driving summary display including first indicators of levels of safe driving behavior for each of the one or more telemetry factors, where each first indicator corresponds to a different range of driver performance metrics. For each of the one or more telemetry factors for the user, the method includes presenting a second indication of the driver performance metric corresponding to the telemetry factor within the driving summary display, where the second indication is presented in the driving summary display within a corresponding range for the driver performance metric, so that the user is made aware of the telemetry factors in which to improve upon.

In another embodiment, a client computing device for presenting driver performance metrics on a user interface is provided. The client computing device includes a user interface, one or more processors and a non-transitory computer-readable memory coupled to the user interface and the one or more processors and storing instructions thereon. When executed by the one or more processors, the instructions cause the client computing device to determine one or more driver performance metrics for one or more telemetry factors based on vehicle data for a user collected over a time interval, and present, via the user interface, a driving summary display indicative of driver performance for each of the one or more telemetry factors, the driving summary display including first indicators of levels of safe driving behavior for each of the one or more telemetry factors, where each first indicator corresponds to a different range of driver performance metrics. For each of the one or more telemetry factors for the user, the instructions cause the client computing device to present, via the user interface, a second indication of the driver performance metric corresponding to the telemetry factor within the driving summary display, where the second indication is presented in the driving summary display within a corresponding range for the driver performance metric, so that the user is made aware of the telemetry factors in which to improve upon.

### BRIEF DESCRIPTION OF THE DRAWINGS

The figures described below depict various aspects of the system and methods disclosed therein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A illustrates an example vehicle in which the techniques of the present disclosure can be used to present a driving summary display;

FIG. 1B illustrates a block diagram of a computer network and system on which an exemplary driver performance system may operate in accordance with the presently described embodiments;

FIG. 2 illustrates a block diagram of an exemplary client device and an exemplary vehicle head unit that can operate in the system of FIG. 1A;

FIG. 3A illustrates an exemplary driving summary display of a driver performance application in accordance with the presently described embodiments;

FIG. 3B illustrates an exemplary display of an explanation for how to qualify for benefits via the driver performance application in accordance with the presently described embodiments;

FIG. 3C illustrates an exemplary display of the particular benefits corresponding to a first level of safe driving behavior in a driver performance application in accordance with the presently described embodiments;

FIG. 3D illustrates an exemplary display of the particular benefits corresponding to a second level of safe driving behavior in a driver performance application in accordance with the presently described embodiments;

FIG. 3E illustrates an exemplary display of driver performance related to a braking telemetry factor in a driver performance application in accordance with the presently described embodiments;

FIG. 3F illustrates an exemplary display of driver performance related to a speeding telemetry factor in a driver performance application in accordance with the presently described embodiments;

FIG. 3G illustrates an exemplary display of driver performance related to a maneuvering telemetry factor in a driver performance application in accordance with the presently described embodiments;

FIG. 3H illustrates an exemplary display of driver performance related to an acceleration telemetry factor in a driver performance application in accordance with the presently described embodiments;

FIG. 3I illustrates another exemplary driving summary display of a driver performance application including a comparison of multiple drivers in accordance with the presently described embodiments; and

FIG. 4 illustrates a flow diagram representing an exemplary method for presenting driver performance metrics on a user interface in accordance with the presently described embodiments.

### DETAILED DESCRIPTION

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Accordingly, as used herein, the term “telemetry factor” may refer to a particular type of vehicle telematics data collected by sensors at a client device or vehicle head unit, such as telematics data related to braking, acceleration, speeding, maneuvering, etc.

The term “driver performance metric” as used herein may refer to a measure of the user's safe driving behavior for a particular telemetry factor compared with the driving habits of a sample population of other drivers. In some scenarios, the driver performance metric may be a score from one to one hundred that rates the user's driving behavior for a particular telemetry factor, such as braking. For example, scores between 50 and 69 may indicate that the user is about as safe as the average driver with respect to the particular telemetry factor (e.g., the user has about the same number of harsh braking events in a month as the average driver). Scores below 50 may indicate the user takes significantly more risks than the average driver with respect to the particular telemetry factor (e.g., the user has more harsh braking events in a month than the average driver). Scores above 70 may indicate that the user takes significantly less risks than the average driver with respect to the particular telemetry factor (e.g., the user has less harsh braking events in a month than the average driver).

Generally speaking, techniques for presenting driver performance metrics may be implemented in one or several client devices, a vehicle head unit, one or several network servers or a system that includes a combination of these devices. However, for clarity, the examples below focus primarily on an embodiment in which a client device collects vehicle data via sensors at the client device, such as an accelerometer, global positioning system (GPS) module, inertial measurement unit (IMU), gyroscope, etc., or by communicating with a vehicle head unit to receive the vehicle data from sensors at the head unit. The vehicle data may then be transmitted to a driver performance analysis server which analyzes the vehicle data for a particular user over a time interval (e.g., the past month or 30 days). The vehicle data may be analyzed to determine a driver performance metric for each of several telemetry factors, such as braking, speeding, acceleration, or maneuvering. Additionally, the driver performance analysis server may combine the driver performance metrics for each telemetry factor to determine amounts remaining until a user reaches each of the levels of safe driving behavior and qualifies for corresponding benefits. The driver performance metrics and indications of the amounts remaining may then be provided to the client device.

Accordingly, the client device may present a driving summary display to the user, including indications of the driver performance metrics for each of the telemetry factors along with indications of ranges of driver performance metrics corresponding to each level of safe driving behavior. Moreover, for each level of safe driving behavior (e.g., a star level, a shield level, etc.), the client device may present an indication of the amount remaining until the user reaches the respective level and qualifies for a corresponding benefit.

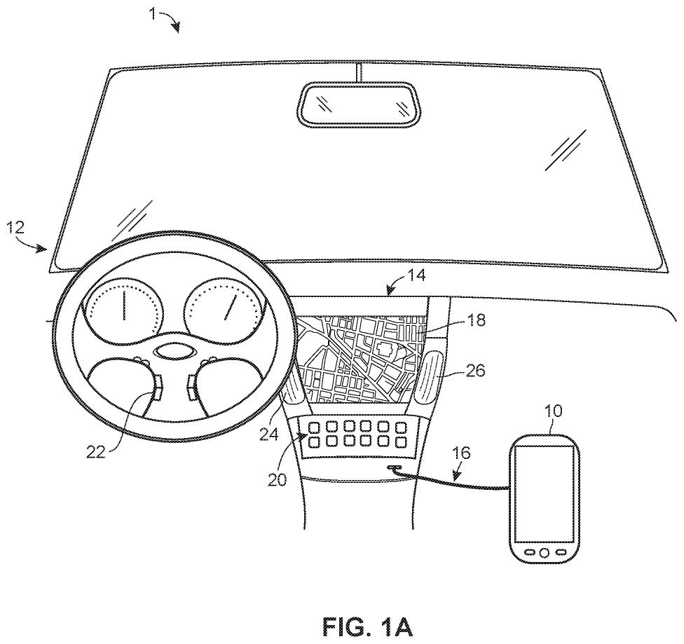

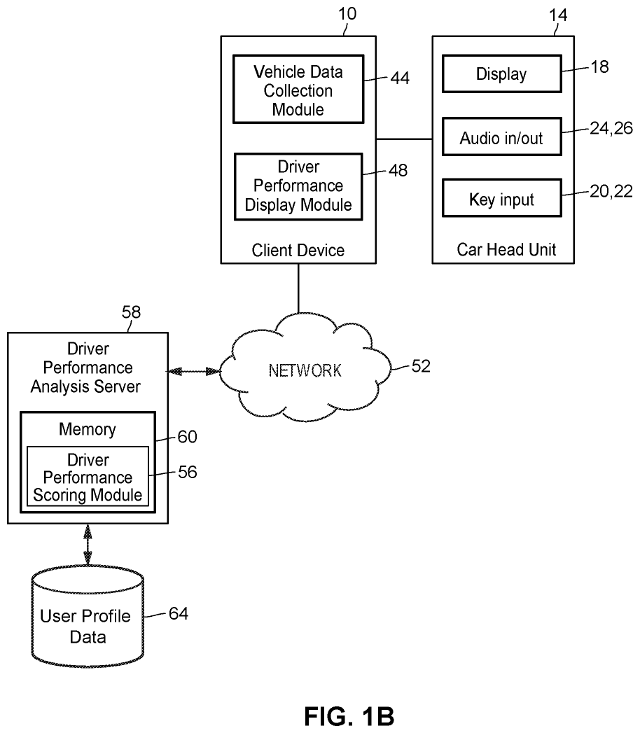

Referring to FIG. 1A, an example environment 1 in which the techniques outlined above can be implemented includes a client device 10 and a vehicle 12 with a head unit 14. The client device 10 may include, by way of example, various types of “mobile devices,” such as a tablet computer, a cell phone, a personal digital assistant (PDA), a smart-phone, a laptop computer, a desktop computer, a portable media player, a home phone, a pager, a wearable computing device, smart glasses, smart watches or bracelets, phablets, other smart devices, devices configured for wired or wireless RF (Radio Frequency) communication, etc. Additionally, any client device appropriately configured may interact with the driver performance system. Moreover, while the example environment 1 includes one client device 10, any number of client devices 10 may be included in the example environment 1 such that two or more client devices may communicate with each other.

In any event, the client device 10 may communicate with the head unit 14 of the vehicle 12 (vehicle head unit) via a communication link 16, which may be wired (e.g., Universal Serial Bus (USB)) or wireless (e.g., Bluetooth, Wi-Fi Direct). The client device 10 also can communicate with various content providers, servers, etc., via a wireless communication network such as a fourth- or third-generation cellular network (4G or 3G, respectively), a Wi-Fi network (802.11 standards), a WiMAX network, a wide area network (WAN), a local area network (LAN), etc.

In some instances, the client device 10 may communicate with the wireless communication network via wireless signals and, in some instances, may communicate with the wireless communication network via an intervening wireless or wired device, which may be a wireless router, a wireless repeater, a base transceiver station of a mobile telephony provider, etc.

The vehicle head unit 14 can include a display 18 such as a digital map. The display 18 in some implementations is a touchscreen and includes a software keyboard for entering text input, which may include the name or address of a destination, point of origin, etc. Hardware input controls 20 and 22 on the vehicle head unit 14 and the steering wheel, respectively, can be used for entering alphanumeric characters or to perform other functions for requesting navigation directions. The vehicle head unit 14 also can include audio input and output components such as a microphone 24 and speakers 26, for example. The speakers 26 can be used to play the audible alert sent from the client device 10, such as sounds and/or voice announcements.

FIG. 1B illustrates an example communication system in which the client device 10 can operate to collect vehicle data and present a driving summary display. For ease of illustration, the client device 10 and the vehicle head unit 14 are illustrated in FIG. 1B in a simplified manner, without some of the components illustrated in FIG. 1B and/or discussed elsewhere in this disclosure.

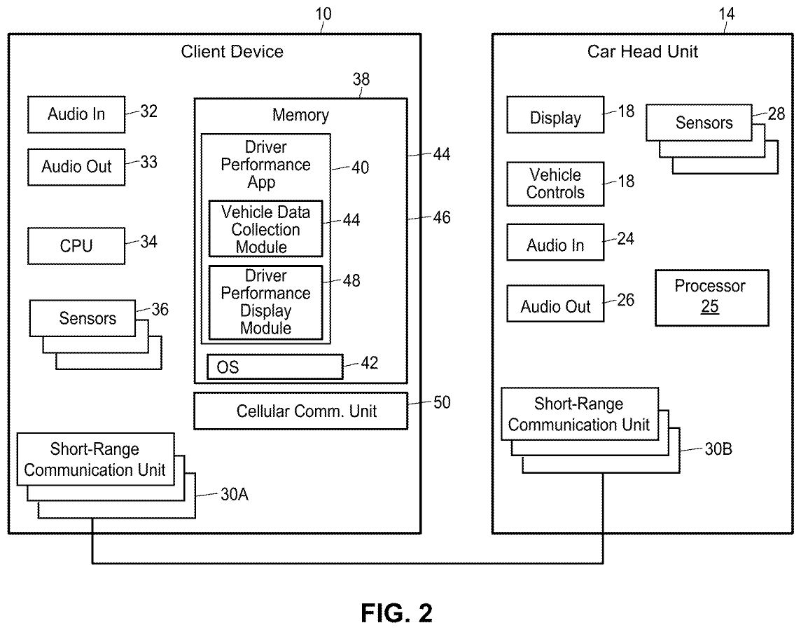

The client device 10 may have access to a wide area communication network 52 such as the Internet via a long-range wireless communication link (e.g., a cellular link). Referring to FIG. 2B, the client device 10 can access the communication network 52 via the cellular communication unit 50. In the example configuration of FIG. 1B, the client device 10 may communicate with a driver performance analysis server 58 which may determine driver performance metrics for telemetry factors and amounts remaining until the user reaches various levels of safe driving behavior based on the driver performance metrics via a driver performance scoring module 56. The driver performance analysis server 58 may also generate and/or transmit data for presenting application screens or web pages on the client device 10.

In some implementations the vehicle data collection module 44 and/or the driver performance display module 48 can be a part of the driver performance analysis server 58, the client device 10, or a combination of the driver performance analysis server 58 and the client device 10. Although only one driver performance analysis server 58 is depicted in FIG. 1B, multiple driver performance analysis servers 58 may be provided for the purpose of distributing server load, serving different web pages, etc. These multiple driver performance analysis servers 58 may include a web server, an entity-specific server (e.g. an Apple® server, etc.), a server that is disposed in a retail or proprietary network, etc. For example, a first driver performance analysis server may include the driver performance scoring module 56 and a second driver performance analysis server 58 may include a web server or application server for generating and transmitting web pages or application screens.

The driver performance analysis server 58 may include a controller. The controller may include a program memory 60, a microcontroller or a microprocessor (MP), a random-access memory (RAM), and/or an input/output (I/O) circuit, all of which may be interconnected via an address/data bus. In some embodiments, the controller may also include, or otherwise be communicatively connected to, a database or other data storage mechanism (e.g., one or more hard disk drives, optical storage drives, solid state storage devices, etc.), such as a user profile database 64.

The user profile database 64 may include user profiles for each of the users including unique identification information for the user, such as a username or user ID, biographical information for the user, such as the user's first and last name, address, date of birth, etc., vehicle identification information for the vehicles registered to the user such as the make, model, and year of the vehicles or a vehicle identification number (VIN) for each of the vehicles. The user profiles may also include historical driver performance data for the user for each of the telemetry factors. For example, as mentioned above, the driver performance metric for each telemetry factor is based on the number of unsafe driving events or the amount of time in which the unsafe driving events occurred over a particular time interval. Accordingly, the user profiles may include indications of each of the unsafe driving events, the date and/or time in which they occurred, and/or the amount of time in which they occurred. For example, a harsh braking event may be identified for John Doe on Jun. 20, 2018. This instance of a harsh braking event would be included in the total number of harsh braking events when determining the number of harsh braking events for John Doe over the past 30 days on Jul. 18, 2018. However, when determining the number of harsh braking events for John Doe over the past 30 days on Jul. 21, 2018, this instance of a harsh braking event would no longer be included. In another example, a speeding event may be identified for Jane Smith on Aug.13, 2018 from 5 p.m. to 5:30 p.m. As a result, 30 minutes would be added to the total amount of time in which the user engaged in a speeding event over the past 30 days, and this amount of time would be removed from the calculation on Sep. 14, 2018.

Furthermore, the user profile may include indications of the levels of safe driving behavior achieved by the user along with indications of the amounts remaining until the user reaches other levels of safe driving behavior. For example, John Doe's user profile may include three stars, two shields, and indications that John Doe is 80 percent of the way to earning another star and 25 percent of the way to earning another shield. When one or several of the levels of safe driving behavior are traded in for a corresponding benefit, the traded in levels may be removed from the user profile.

In any event, the controller may also include, or otherwise be communicatively connected to, a database which stores web page templates and/or web pages, application screen templates and/or application screens, and other data necessary to interact with users. The controller may implement the RAM(s) and/or the program memories as semiconductor memories, magnetically readable memories, and/or optically readable memories, for example.

The program memory 60 and/or the RAM may store various applications for execution by the microprocessor. For example, the driver performance module 56 may obtain vehicle data for a user, analyze the vehicle data to identify driver performance metrics for several telemetry factors, and combine the driver performance metrics to determine amounts remaining until the user reaches various levels of safe driving behavior and qualifies for corresponding benefits. In some embodiments, the driver performance module 56 periodically updates the driver performance metrics and amounts remaining until the user reaches various levels of safe driving behavior (e.g., once per day, once an hour, etc.). In other embodiments, updates are made in real-time or at least near real-time as additional vehicle data is received and/or as speeding, braking, acceleration, or maneuvering events are identified.

More specifically, the driver performance analysis server 58 may receive the vehicle data from the client device 10. The driver performance scoring module 56 may determine a driver performance metric as a score from one to one hundred for each of the telemetry factors based on the number of unsafe driving events or the amount of time in which the unsafe driving events occurred over a particular time interval. In some embodiments, the client device 10 may identify braking, speeding, acceleration, or maneuvering events by comparing vehicle data to a braking (e.g., 0.4 G), speeding (e.g., 80 miles per hour), acceleration (e.g., 0.3 G), or maneuvering threshold (e.g., 0.2 G). Then the client device 10 may transmit an indication of the type of unsafe driving event (e.g., a braking event), the date and/or time of the unsafe driving event, and/or the amount of time in which the unsafe driving event occurred to the driver performance analysis server 58. In other embodiments, the client device 10 transmits raw vehicle data to the driver performance analysis server 58, and the driver performance analysis server 58 may compare the raw vehicle data to a braking, speeding, acceleration, or maneuvering threshold to identify an unsafe driving event.

For each telemetry factor, the driver performance scoring module 56 may identify the number of unsafe driving events over a particular time interval (e.g., 20 harsh braking events over the past 30 days) or the amount of time in which the unsafe driving events occurred over the particular time period (e.g., 70 minutes of speeding events over the past 30 days). Then the driver performance scoring module 56 may assign a score to each telemetry factor by comparing the number of unsafe driving events or the amount of time in which the unsafe driving events occurred over the particular time period to a statistical model based on the driving behavior of other drivers over the same time period. For example, the user may be assigned a score of 70 for braking when she has the same number of harsh braking events over the past 30 days as the average driver according to the statistical model. In another example, the user may be assigned a score of 90 for acceleration when she has over one standard deviation less hard acceleration events over the past 30 days than the average driver according to the statistical model.

The driver performance scoring module 56 may then combine each of the driver performance metrics for the telemetry factors to identify an overall driver performance metric or score for the user. The overall score may then be used to adjust the amounts remaining until the user reaches each of the levels of safe driving behavior. In some embodiments, an overall score may be calculated for each of the levels of safe driving behavior, such as a first overall score for the star level and a second overall score for the shield level. The driver performance scoring module 56 may calculate the overall scores by comparing each of the driver performance metrics to driver performance metric ranges corresponding to each level of safe driving behavior. In some embodiments, each telemetry factor may be assigned a weight, where the overall score is based on a weighted combination of the driver performance metrics for the telemetry factors. In other embodiments, the driver performance metrics for the telemetry factors may be combined in any suitable manner to determine the overall scores for each level of safe driving behavior.

For example, the star level may correspond to a range of scores between 70 and 89 and the shield level may correspond to a range of scores between 90 and 100. When a braking score is below 70, for example, the braking score does not count toward the star level score or the shield level score. On the other hand, when the braking score is between 70 and 89, the braking score counts toward the star level score but does not count toward the shield level score. The driver performance scoring module 56 may assign higher star level scores to braking scores that are higher within the range (e.g., a higher star level score is assigned to a braking score of 85 than to a braking score of 72). When the braking score is above 90, the braking score counts toward both the star level and the shield level scores, and the driver performance scoring module 56 may assign higher shield level scores to braking scores that are higher within the range (e.g., a higher shield level score is assigned to a braking score of 98 than to a braking score of 92).

Then the driver performance scoring module 56 may determine the amounts remaining until the user reaches each of the levels of safe driving behavior based on the overall scores. For example, the driver performance scoring module 56 may determine the amount remaining until the user reaches the star level based on the star level score, and may determine the amount remaining until the user reaches the shield level based on the shield level score. The amount remaining may have an inverse relationship with the corresponding overall score, such that a higher overall score for a particular level of safe driving behavior corresponds to a lower amount remaining until the user reaches the particular level. In some embodiments, an overall score for a particular level may reset each time the user reaches the level. For example, when the user reaches the star level (e.g., the user has an amount remaining of zero or less than a threshold amount for the star level), the user's overall score for the star level is reset to zero.

Indications of the driver performance metrics for each telemetry factor and the amounts remaining until the user reaches each level of safe driving behavior may be provided to the client device 10 to be presented in a driving summary display on a user interface. The client device 10 may then present the driving summary display on the client device 10 and/or the display 18 of the vehicle head unit 14 (e.g., by invoking a vehicle communication API (such as Apple CarPlay™)).

An example implementation of the client device 10 and the vehicle head unit 14 is discussed next with reference to FIG. 2. As discussed above, the vehicle head unit 14 may include a display 18, hardware controls 20, 22, an audio input unit 24, and an audio output unit 26. The vehicle head unit 14 also may include a processor 25, a set of one or several sensors 28, and one or several short-range communication units 30B. The set of sensors 28 may include, for example, a GPS module to determine the current position of the vehicle in which the vehicle head unit 14 is installed, an IMU to measure the speed, acceleration, and current orientation of the vehicle, etc. Although FIG. 2 depicts the set of sensors inside the vehicle head unit 14, it is noted that the sensors 28 need not be integral components of the vehicle head unit 14. Rather, a vehicle may include any number of sensors in various locations, and the vehicle head unit 14 may receive data from these sensors during operation.

A short-range communication unit 30B may allow the vehicle head unit 14 to communicate with the client device 10. The short-range communication unit 30B may support wired or wireless communications, such as USB, Bluetooth, Wi-Fi Direct, Near Field Communication (NFC), etc. The processor 25 may operate to format messages transmitted between the vehicle head unit 14 and the client device 10, process data from the sensors 28 and the audio input 24, display map images via the display 18, play audio via the audio output 26, etc.

The client device 10 may include a short-range communication unit 30A for communicating with the vehicle head unit 14. Similar to the unit 30B, the short-range communication unit 30A may support one or more communication schemes such as USB, Bluetooth, Wi-Fi Direct, NFC, etc. The client device 10 may include a display 40 and audio input and output components such as a microphone 32 and speakers 33. Additionally, the client device 10 may include one or more processors or CPUs 34, a set of one or several sensors 36 including a GPS module, an IMU, an accelerometer to measure the acceleration of the client device 10, and/or a gyroscope to measure the orientation of the client device 10, a memory 38, and a cellular communication unit 50 to transmit and receive data via a 3G cellular network, a 4G cellular network, or any other suitable network. The client device 10 can also include additional sensors or, conversely, the client device 10 can rely on sensor data supplied by the vehicle head unit 14. In one implementation, to improve accuracy during real-time navigation, the client device 10 relies on the positioning and speed data supplied by the vehicle head unit 14 rather than on the output of the GPS module 36.

The memory 38 may be tangible, non-transitory memory and may include any types of suitable memory modules, including random access memory (RAM), read-only memory (ROM), flash memory, other types of persistent memory, etc. The memory 38 may store, for example instructions executable on the processors 34 of an operating system 42, a driver performance application 40, a vehicle data collection module 44, and a driver performance display module 48.

The driver performance application 40 may collect vehicle data or indications of braking, speeding, maneuvering, or acceleration events for a user, determine driver performance metrics for each telemetry factor and amounts remaining until the user reaches each level of safe driving behavior, and provide indications of the driver performance metrics and amounts remaining to the client device 10. The driver performance application 40 may be a single module or may include a plurality of modules such as the vehicle data collection module 44 and the driver performance display module 48. While the driver performance application 40 is depicted in FIG. 2 as including two modules 44 and 48, the driver performance application 40 may include any number of modules accomplishing tasks related to implementation of the client device 10.

The vehicle data collection module 44 may collect vehicle data from the sensors 36 at the client device or the sensors 28 at the vehicle head unit 14. The vehicle data may include forward acceleration data, deceleration data due to braking, lateral acceleration data due to cornering, speed data, position data, or any other suitable data related to maneuvering the vehicle. In some embodiments, the vehicle data collection module 44 may compare the forward acceleration data to an acceleration threshold (e.g., 0.3 G) to determine whether a hard acceleration event occurred. In response to identifying a hard acceleration event, the vehicle data collection module 44 may transmit information regarding the hard acceleration event to the driver performance analysis server 58, such as the type of unsafe driving event, the date and/or time of the unsafe driving event, the amount of time in which the vehicle accelerated above the threshold, etc. The vehicle data collection module 44 may transmit similar information for a speeding event, braking event, or maneuvering event. In other embodiments, the vehicle collection module 44 may transmit the raw vehicle data to the driver performance analysis server 58, and the driver performance analysis server 58 may compare the raw vehicle data to various thresholds to identify unsafe driving events.

The driver performance display module 48 may present a driving summary display on a user interface of the client device 10 or the vehicle head unit 14. The driving summary display may include indications of driving performance metrics for each of the telemetry factors. Additionally, the driving summary display may include indications of levels of safe driving behavior and ranges of driver performance metrics corresponding to each level of safe driving behavior. Moreover, each indication of a level of safe driving behavior may include a fill level that corresponds to the amount remaining until the user reaches the level of safe driving behavior. For example, a star level may include a graphic depiction of a star that is half filled in, indicating that the user is half of the way to earning a star.

In some embodiments, the driver performance application 40 may invoke a vehicle communication API to collect vehicle data from the vehicle head unit 14 or present the driving summary display on the vehicle head unit 14. More generally, by invoking the vehicle communication API, the driver performance application 40 may receive information from the vehicle head unit 14 and/or may control operation of input/output devices in the vehicle head unit 14, such as the display 18. The software components 42, 44, and 48 can include compiled instructions and/or instructions in any suitable programming language interpretable at runtime. In any case, the software components 42, 44, and 48 execute on the one or more processors 34.

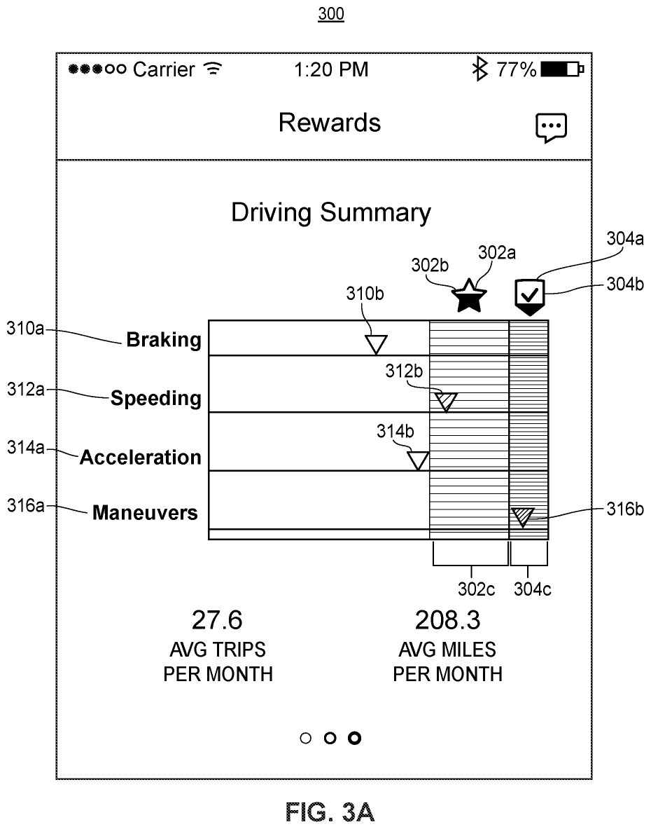

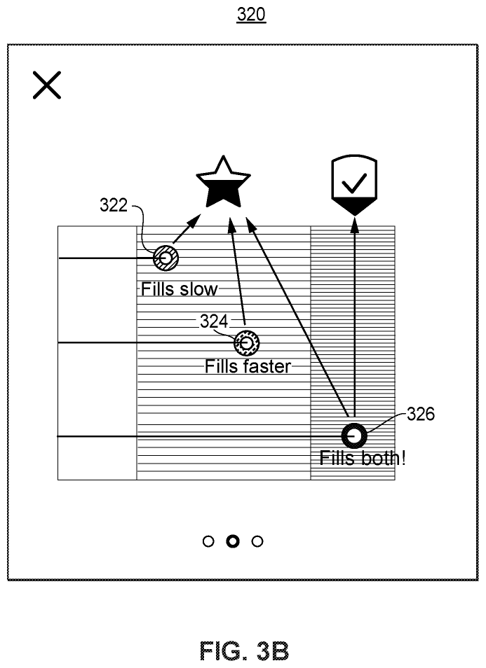

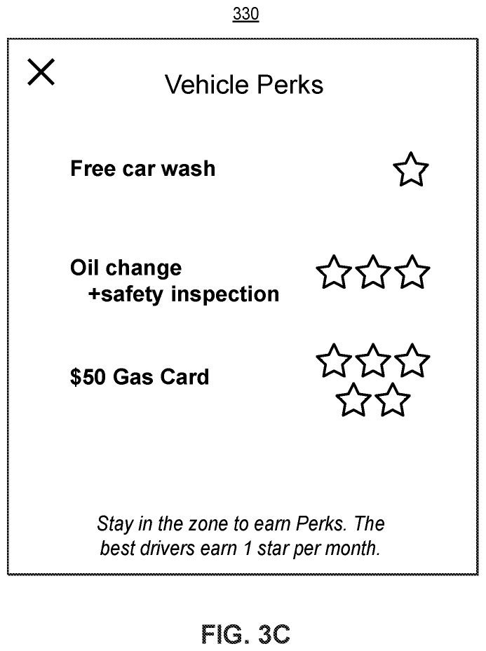

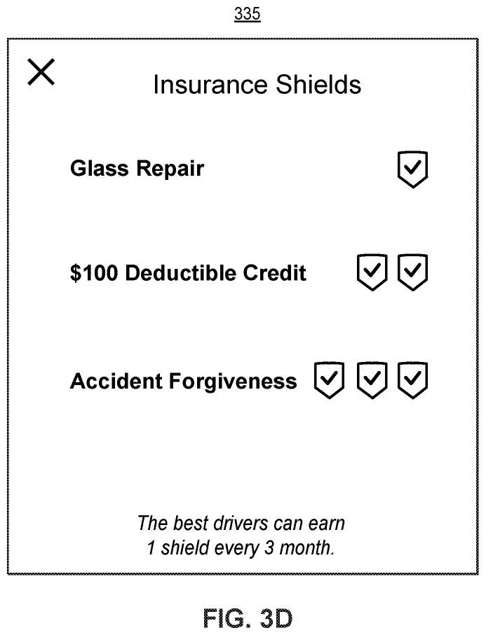

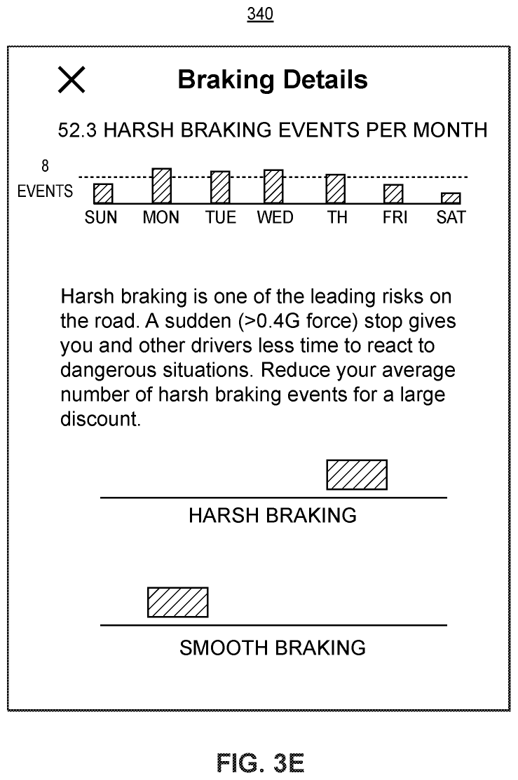

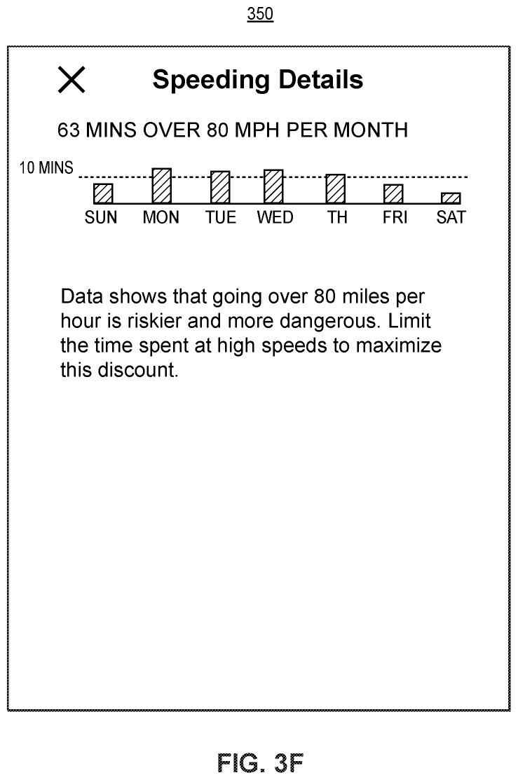

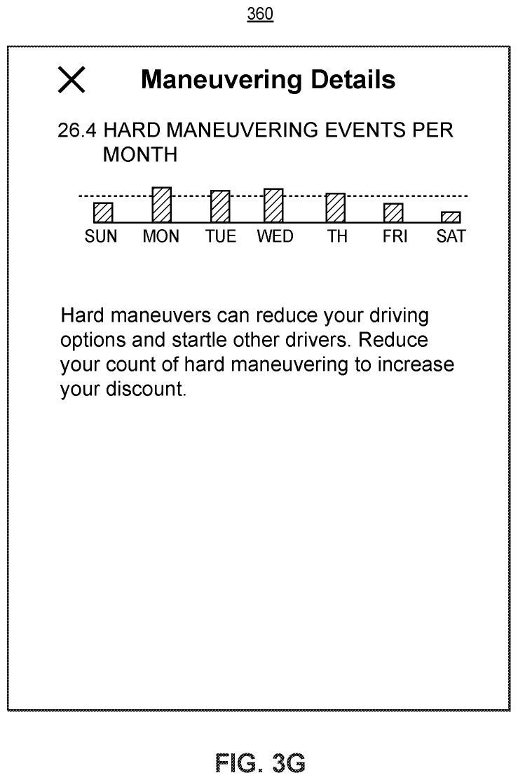

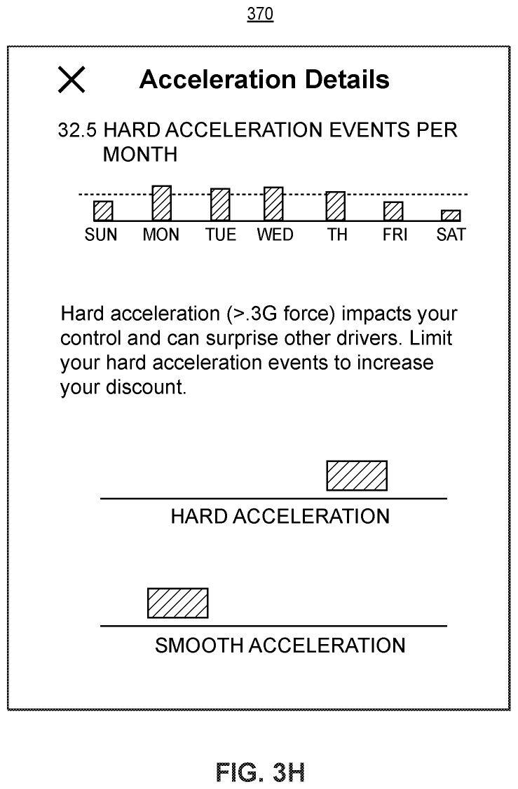

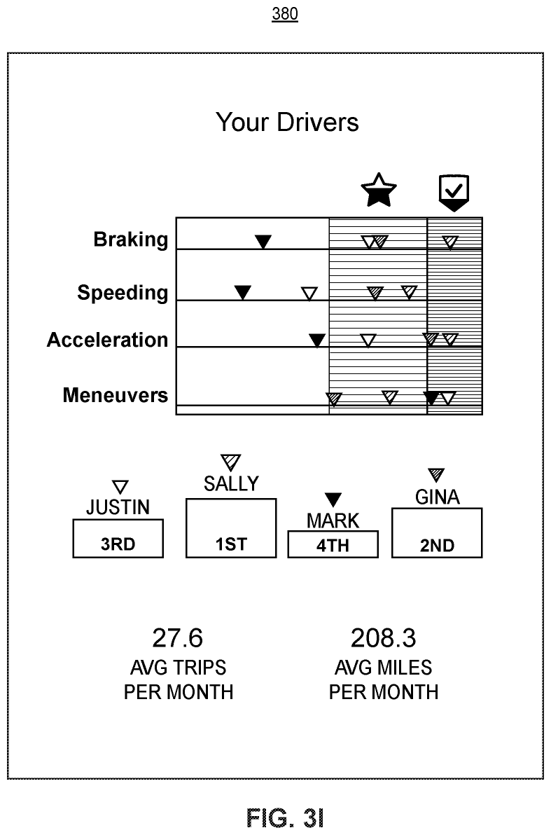

FIGS. 3A-3I depict exemplary displays presented by the driver performance application 40 as shown in FIG. 2, which may be generated, at least in part by the driver performance analysis server 58 and displayed by the driver performance display module 44 of the client device 10, and/or provided to the vehicle head unit 14 for display. As will be appreciated by those of ordinary skill in the relevant art(s), the exemplary displays shown in FIGS. 3A-3I are for illustrative purposes, and the associated functionality may be implemented using any suitable format and/or design for facilitating corresponding described functionalities without departing from the spirit and scope of the present disclosure. In some embodiments, the driver performance analysis server 58 may transmit web pages.

As mentioned above, the driver performance analysis server 58 may receive vehicle data from the client device 10, and may determine a driver performance metric for each of the telemetry factors. Then the driver performance analysis server 58 may determine the amounts remaining until the user reaches each of several levels of safe driving behavior based on a combination of the driver performance metrics. Furthermore, the driver performance analysis server 58 may provide indications of the driver performance metrics for each telemetry factor and the amounts remaining until the user reaches each level of safe driving behavior to the client device 10 to be presented in a driving summary display. FIG. 3A depicts an exemplary driving summary display 300 of a driver performance application 40 presented on the client device 10.

The driving summary display 300 includes indications of first and second levels of safe driving behavior 302a, 302a, such as a star level 302a and a shield level 302a. The star level 302a includes a vehicle care indicator, such as a graphic depiction of a star. Below the graphic depiction of the star, the star level 302a includes an indication of a range of driver performance metrics 302c that corresponds to the star level 302a (e.g., from 70 to 89 out of 100). Moreover, the graphic depiction of the star is partially filled 302b with the unfilled portion indicating the amount remaining until the user earns another star. Additionally, the shield level 302a includes an accident forgiveness indicator, such as a graphic depiction of a shield. Below the graphic depiction of the shield, the shield level 302a includes an indication of a range of driver performance metrics 304c that corresponds to the shield level 302a (e.g., from 90 to 100 out of 100). Moreover, the graphic depiction of the shield is partially filled 304b with the unfilled portion indicating the amount remaining until the user earns another shield.

The driving summary display 300 also includes several telemetry factors: braking 310a, speeding 312a, acceleration 314a, and maneuvers 316a. For each telemetry factor, the driving summary display 300 presents an indication 310b-316b of the driver performance metric for the telemetry factor, where the indication of the driver performance metric 310b is presented within a corresponding range.

For example, the driver performance metric 310b for braking 310a may be a score of 55 which is less than the minimum score for the star level 302a and the shield level 302a. As a result, the indication of the driver performance metric 310b for braking 310a is placed outside of the corresponding ranges 302c, 304c for the star and the shield levels. The driver performance metric 312b for speeding 312a may be a score of 72 which is within the range of driver performance metrics 302c for the star level. Accordingly, the indication of the driver performance metric 312b for speeding is placed within the range of driver performance metrics 302c for the star level, and near the beginning of the range. The driver performance metric 314b for acceleration 312a may be a score of 68 which is less than the minimum score for the star level 302a and the shield level 302a. As a result, the indication of the driver performance metric 314b for speeding 314a is placed outside of the corresponding ranges 302c, 304c for the star and the shield levels. In yet another example, the driver performance metric 316b for maneuvers 316a may be a score of 94 which is within the range of driver performance metrics 304c for the shield level. Accordingly, the indication of the driver performance metric 316b for maneuvering is placed within the range of driver performance metrics 304c for the shield level, and toward the middle of the range.

While the indications of the driver performance metrics 310b-316b are represented as triangles, the driving summary display 300 may include any suitable indication for the driver performance metrics 310b-316b. This may include a circle, a square, a rectangle, a check mark, an ‘X,” an icon representing a vehicle or the user, etc.

To determine the amount remaining until the user reaches each level of safe driving behavior, the driver performance analysis server 58 may combine each of the driver performance metrics for the telemetry factors to identify an overall driver performance metric or score for each level of safe driving behavior for the user. When a driver performance metric for a particular telemetry factor is outside of the ranges of driver performance metrics for each of the levels of safe driving behavior, the driver performance metric does not contribute toward any of the overall scores. On the other hand, when the driver performance metric for a particular telemetry factor is within one of the ranges of driver performance metrics for a particular level of safe driving behavior, the driver performance metric contributes toward the overall score for the particular level of safe driving behavior. The driver performance metric also may contribute toward the overall score for lower levels of safe driving behavior. For example, when a driver performance metric is within the range of driver performance metrics corresponding to a second level of safe driver behavior, the driver performance metric contributes to the overall score for both of the first and second levels of safe driving behavior. Additionally, the driver performance analysis server 58 may assign higher overall scores for a particular level of safe driving behavior to driver performance metrics that are higher within the range (e.g., a higher star level score is assigned to a braking score of 85 than to a braking score of 72).

The overall scores for each level of safe driving behavior may then be used to determine the amount remaining until the user reaches the level. For example, as the overall score for a particular level of safe driving behavior increases, the amount remaining until the user reaches the particular level decreases. The amount remaining until the user reaches the particular level may decrease linearly as a function of the overall score for the particular level, quadratically, polynomially, exponentially, logarithmically, or in any suitable manner. In some embodiments, the overall scores are calculated periodically (e.g., once per day, once per week, once an hour, etc.) based on the most recent driver performance metrics for the user. Each time the overall scores are calculated, the amount remaining until the user reaches each level is updated. For example, an overall score for the star level of 75 may correspond to a two percent reduction per day in the amount remaining until the user reaches the star level. If the user maintains an overall score of 75 each day for several consecutive days (e.g., five days), she may receive a two percent reduction per day over the time period in the amount remaining until the user reaches the star level (e.g., from 100 percent remaining to 90 percent). If the user increases her score on the following day, she may receive greater than a two percent reduction for that day, and if she decreases her score, she may receive less than a two percent reduction for that day.

In any event, FIG. 3B depicts a schematic diagram 320 of an exemplary explanation for how to reach each level in the driver performance application 40. As shown by the indicator 322, a driver performance metric on the lower end of the range for the first level of safe driving behavior may cause the first level to fill slowly, thereby causing a slow reduction in the amount remaining until the user reaches the first level of safe driving behavior (e.g., one percent per day). On the other hand, a driver performance metric on the higher end of the range for the first level of safe driving behavior 324 may cause the first level to fill faster, thereby causing a faster reduction in the amount remaining until the user reaches the first level of safe driving behavior (e.g., two percent per day). Furthermore, a driver performance metric in the range for the second level of safe driving behavior may cause the first level to fill even faster, thereby causing an even faster reduction in the amount remaining until the user reaches the first level of safe driving behavior (e.g., three percent per day). A driver performance metric in the range for the second level of safe driving behavior may also cause the second level to fill, thereby causing a reduction in the amount remaining until the user reaches the second level of safe driving behavior.

When the user reaches a level of safe driving behavior, she qualifies to receive a benefit corresponding to the level. The driver performance application 40 may include user controls for the user to redeem the level of safe driving behavior for the corresponding benefit. Additionally, the driver performance application 40 and/or the driver performance analysis server 58 may store the number of times the user has reached a particular level of safe driving behavior. Upon reaching a threshold number, the user may qualify to receive additional benefits. When the level(s) of safe driving behavior are redeemed for benefits, the driver performance application 40 and/or the driver performance analysis server 58 decrements the number of times the user reached the particular level of safe driving behavior based on the number of levels redeemed.

FIG. 3C illustrates an exemplary display 330 presented by the driver performance application 40 indicating the benefits which may be provided to the user for reaching the star level. For example, one star may be exchanged for a free car wash. Three stars may be exchanged for an oil change and a safety inspection, and five stars may be exchanged for a $50 gas card. FIG. 3D illustrates an exemplary display 335 presented by the driver performance application 40 indicating the benefits which may be provided to the user for reaching the shield level. For example, one shield may be exchanged for glass repair. Two shields may be exchanged for a $100 deductible credit, and three shields may be exchanged for accident forgiveness.

In some embodiments, the driver performance application 40 may present a display indicating the number of times the user has reached each level of safe driving behavior (e.g., 12 stars and 15 shields). The display may also include user controls for selecting the number of stars and/or shields to redeem and the corresponding benefit. Accordingly, the driver performance analysis server 58 may provide a coupon to the driver performance application 40 to select retailers for the free car wash, oil change, etc.

In other embodiments, the driver performance analysis server 58 may provide credits or rewards points to the driver performance application 40 which may be redeemable at the organization that provides the driver performance system. For example, an insurance company may generate the driver performance application 40 and corresponding software on the server devices. The driver performance analysis server 58 may store the amount of deductible credit or accident forgiveness for the user in her user profile. Then the user can redeem the deductible credit or accident forgiveness with the insurance company, via the driver performance application 40 or another application provided by the insurance company, in the event of a vehicle collision or other claim.

In yet other embodiments, the driver performance analysis server 58 may provide a digital currency to the user, such as a cryptocurrency or digital token in an amount that is equivalent to the benefit, as described in co-pending U.S. patent application Ser. No. ______ (Attorney Docket no. 32817/51733 entitled “METHOD AND SYSTEM FOR PROVIDING SAFE DRIVING BEHAVIOR BENEFITS,” and incorporated by reference herein. In this manner, the user may redeem the cryptocurrency or digital token at any retailer in exchange for the benefit (e.g., a car wash), or may utilize in the cryptocurrency or digital token in any other suitable manner (e.g., in exchange for other goods or services).

Turning back to FIG. 3A, in some embodiments, each of the indications of the telemetry factors may include selectable user controls for viewing additional information on the user's driving performance with respect to the telemetry factor. For example, in response to a touch selection of the braking indicator 310a or the indication of the driver performance metric 310b corresponding to braking 310a, the driver performance application 40 may present a detailed display of the user's braking events over a particular time interval (e.g., the past month). FIG. 3E illustrates an example display 340 presented by the driver performance application 40 indicating the user's braking performance on average per month. More specifically, the example display 340 indicates the user averages 52.3 harsh braking events per month, where a harsh braking event occurs when the user brakes with a force above a threshold force of 0.4 G. The example display 340 also includes a detailed chart 342 comparing the user's number of harsh braking events on each of the days of the week. The detailed chart 342 indicates the user engages in harsh braking events more frequently during the week than on the weekends and in particular, on Mondays through Thursdays. In this manner, the user may be made aware that she can improve her driver performance metric for braking by reducing the number of harsh braking events on weekdays.

Furthermore, in response to a touch selection of the speeding indicator 312a or the indication of the driver performance metric 312b corresponding to speeding 312a, the driver performance application 40 may present a detailed display of the user's speeding events over a particular time interval (e.g., the past month). FIG. 3F illustrates an example display 350 presented by the driver performance application 40 indicating the user's speeding performance on average per month. More specifically, the example display 350 indicates the user speeds for 63 minutes per month, where a speeding event occurs when the user drives above 80 miles per hour.

Moreover, in response to a touch selection of the maneuvers indicator 316a or the indication of the driver performance metric 316b corresponding to maneuvers 316a, the driver performance application 40 may present a detailed display of the user's maneuvering events over a particular time interval (e.g., the past month). FIG. 3G illustrates an example display 360 presented by the driver performance application 40 indicating the user's maneuvering performance on average per month. More specifically, the example display 360 indicates the user averages 26.4 hard maneuvering events per month, where a hard maneuvering event occurs when the user turns with a lateral force above a threshold. Additionally, in response to a touch selection of the acceleration indicator 314a or the indication of the driver performance metric 314b corresponding to acceleration 314a, the driver performance application 40 may present a detailed display of the user's acceleration events over a particular time interval (e.g., the past month). FIG. 3H illustrates an example display 370 presented by the driver performance application 40 indicating the user's acceleration performance on average per month. More specifically, the example display 370 indicates the user averages 32.5 hard acceleration events per month, where a hard acceleration event occurs when the user accelerates with a force above a threshold force of 0.3 G.

In addition to presenting indications of driver performance metrics for the user with respect to various driver performance metric ranges corresponding to levels of safe driving behavior, the driver performance application 40 may present a comparison of the user's driving performance with other users. For example, the user and her friends may share their driver performance metrics with each other to see who the best driver is, and to motivate each other to engage in better safe driving habits. As a result, the driver performance application 40 may provide a form of competition to the users for each of them to strive to have the highest driver performance scores within the group.

FIG. 3I illustrates a driving summary display 380 presented by the driver performance application 40 that includes a comparison of multiple drivers including the user. One or several of the users may select user controls to identify a group. For example, Sally may send an invitation to each of the other members to join her group. Each of the users may select user controls to opt-in to sharing driver performance with each other, and the users who opt-in may be included in the group. Then the driving summary display 380 may be presented on each of the group members' client devices 10 for them to see how they compare with other members of the group. In the exemplary display 380 shown in FIG. 3I, Sally is in first place due to her high braking, speeding, and acceleration scores. Gina is in second place followed by Justin who is then followed by Mark who is in last place. Each user may view his driver performance metrics relative to the others to see areas in which he may improve to increase his overall score and ranking. For example, Mark has the lowest braking and speeding score by a wide margin. If he can reduce the deficit in those scores, Mark may be able to catch Justin in third place.

The driving summary display 380 includes indications of driver performance metrics for several telemetry factors for each user: braking, speeding, acceleration, and maneuvers. The driving summary display 380 also includes rankings for the users, which may be based on overall scores determined from a combination of each user's driver performance metrics. In some embodiments, the overall scores for each user are determined based on an average of the individual scores for each telemetry factor. In other embodiments, the overall scores are determined based on a weighted average of the individual scores for each telemetry factor. For example, braking may be weighted higher than speeding.

In any event, the driving summary display 380 that includes a comparison of multiple drivers allows the user to view her performance relative to the other users in the group. This may help users identify areas in which they are lacking and improve upon their overall driving performances.

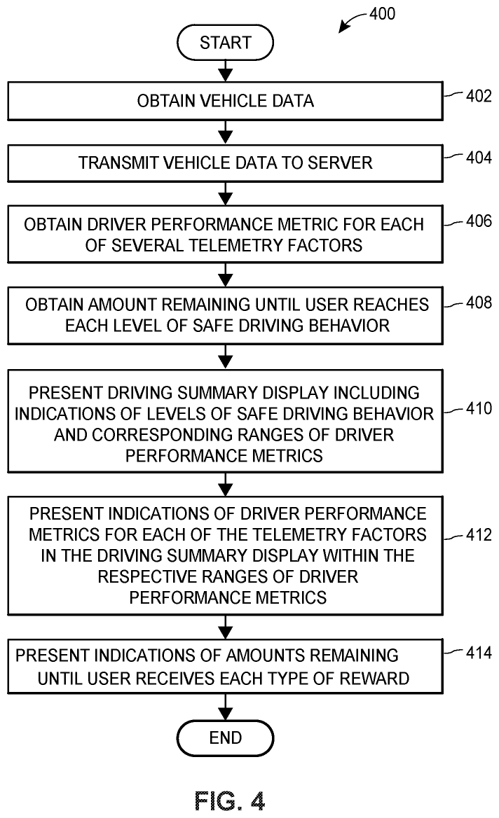

FIG. 4 depicts a flow diagram representing an exemplary method 400 for presenting driver performance metrics on a user interface. The method 400 may be executed on the client device 10. In some embodiments, the method 400 may be implemented in a set of instructions stored on a non-transitory computer-readable memory and executable on one or more processors of the client device 10. For example, the method 400 may be performed by the driver performance application 40, and at least partially performed by the vehicle data collection module 44 and the driver performance display module as shown in FIG. 2.

At block 402, vehicle data is obtained from the sensors 36 at the client device or the sensors 28 at the vehicle head unit 14. The vehicle data may include forward acceleration data, deceleration data due to braking, lateral acceleration data due to cornering, speed data, position data, or any other suitable data related to maneuvering the vehicle. In some embodiments, the vehicle data collection module 44 may compare one of the types of data (e.g., acceleration data) to a threshold to determine whether an unsafe driving event occurred (e.g., a hard acceleration event). In response to identifying an unsafe driving event, the vehicle data collection module 44 may transmit information regarding the unsafe driving event to the driver performance analysis server 58 (block 404), such as the type of unsafe driving event, the date and/or time of the unsafe driving event, the amount of time in which the vehicle accelerated above the threshold, etc. In other embodiments, the vehicle collection module 44 may transmit the raw vehicle data to the driver performance analysis server 58, and the driver performance analysis server 58 may compare the raw vehicle data to various thresholds to identify unsafe driving events. The vehicle data may be transmitted to the driver performance analysis server 58 continuously, as the vehicle data is collected, periodically such as every minute, every five minutes, every hour, every day, etc., each time an unsafe driving event occurs, or in any other suitable manner.

At block 406, the driver performance display module 48 may obtain indications of driver performance metrics for each of the telemetry factors from the driver performance analysis server 58. For example, the driver performance metrics may be scores from one to one hundred based on the number of unsafe driving events or the amount of time in which the unsafe driving events occurred over a particular time interval. The driver performance display module 48 may obtain indications of driver performance metrics for braking, speeding, acceleration, and maneuvers. For each level of safe driving behavior (e.g., the star level, the shield level, etc.), the driver performance display module 48 may obtain an indication of the amount remaining until the user reaches the level and qualifies for a corresponding benefit (block 408).

Then at block 410, the driver performance display module 48 may present a driving summary display, similar to the driving summary display 380 as shown in FIG. 3A. The driving summary display may include indications of first and second levels of safe driving behavior 302a, 302a, such as a star level 302a and a shield level 302a. For example, the star level 302a may include a graphic depiction of a star with a corresponding range of driver performance metrics 302c below the graphic depiction (e.g., from 70 to 89 out of 100).

The driving summary display 300 may also include several telemetry factors: braking 310a, speeding 312a, acceleration 314a, and maneuvers 316a. For each telemetry factor, the driving summary display 300 may present an indication 310b-316b of the driver performance metric for the telemetry factor (block 412), where the indication of the driver performance metric 310b is presented within a corresponding range of driver performance metrics.

For example, the driver performance metric 310b for braking 310a may be a score of 55 which is less than the minimum score for the star level 302a and the shield level 302a. As a result, the indication of the driver performance metric 310b for braking 310a is placed outside of the corresponding ranges 302c, 304c for the star and the shield levels. The driver performance metric 312b for speeding 312a may be a score of 72 which is within the range of driver performance metrics 302c for the star level. Accordingly, the indication of the driver performance metric 312b for speeding is placed within the range of driver performance metrics 302c for the star level, and near the beginning of the range.

Then at block 414, the driver performance display module 48 may present indications of the amount remaining until the user reaches each level of safe driving behavior. For example, as shown in FIG. 3A, the graphic depiction of the star is partially filled 302b with the unfilled portion indicating the amount remaining until the user earns another star. Moreover, the graphic depiction of the shield is partially filled 304b with the unfilled portion indicating the amount remaining until the user earns another shield.

With the foregoing, an insurance customer may opt-in to a rewards, insurance discount, or other type of program. After the insurance customer provides her affirmative consent, an insurance provider remote server (e.g., the driver performance analysis server) may collect data from the customer's mobile device or other smart devices—such as with the customer's permission or affirmative consent. The data collected may be related to insured assets such as the customer's vehicle before (and/or after) an insurance-related event, including those events discussed elsewhere herein, such as unsafe driving events. In return, risk averse insureds may receive discounts or insurance cost savings related to auto and other types of insurance from the insurance provider.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

1. A method for presenting driver performance metrics, the method comprising:
determining, by one or more processors, one or more driver performance metrics for one or more telemetry factors based upon vehicle data of a user collected over a time interval; and
generating, by the one or more processors, a plurality of range indicators, wherein:
each range indicator of the plurality of range indicators represents a level of safe driving behaviors and is associated with a low score and a high score, the low score being greater than zero;
each range indicator of the plurality of range indicators corresponds to a type of benefit to the user;
the plurality of range indicators include a first range indicator and a second range indicator;
the first range indicator is associated with a first graphic and corresponds to a first type of benefits to the user and a first level of safe driving behavior;
the second range indicator is associated with a second graphic and corresponds to a second type of benefits to the user and a second level of safe driving behavior different from the first level of safe driving behavior; and
the first graphic is different from the second graphic;
presenting, by the one or more processors, a driving summary display indicative of the one or more driver performance metrics for the one or more telemetry factors, the driving summary display including:
the plurality of range indicators, and
a performance indication for each driver performance metric of the one or more driver performance metrics,
wherein the performance indication is presented within a corresponding range indicator of the plurality of range indicators for a corresponding telemetry factor;
wherein the first graphic and the second graphic each has a fill level corresponding to an amount remaining until the user reaches a respective level of safe driving behavior;
wherein the fill level of a corresponding graphic increases if one of the one or more driver performance metrics for a corresponding telemetry factor is within or above a range associated with the corresponding telemetry factor;
wherein the fill level of the corresponding graphic increases at a first speed if the one of the one or more driver performance metrics has a first score;
wherein the fill level of the corresponding graphic increases at a second speed if the one of the one or more driver performance metrics has a second score higher than the first score;
wherein the second speed is higher than the first speed.

2. (canceled)

3. The method of claim 1, further comprising:
determining, by the one or more processors, whether to provide a benefit corresponding to one of the plurality of range indicators based upon the performance indication associated with the one or more driver performance metrics and the associated plurality of range indicators.

4. The method of claim 3, wherein:
the user receives a corresponding benefit when the fill level of a corresponding graphic meets or exceeds a threshold value.

5. (canceled)

6. The method of claim 1, wherein the first graphic is presented above the corresponding range of the driver performance metric associated with the first range indicator.

7. The method of claim 3, wherein determining whether to provide the benefit corresponding to the one of the plurality of range indicators includes:
assigning, by the one or more processors, a weight to each driver performance metric of the one or more driver performance metrics; and
determining, by the one or more processors, whether to provide the benefit corresponding to the one of the plurality of range indicators based upon a weighted combination of the one or more driver performance metrics for the one or more telemetry factors.

8. The method of claim 3, further comprising:
providing, by the one or more processors, the benefit to the user based upon the determination.

9. The method of claim 1, wherein:
the first range indicator of the plurality of range indicators is a vehicle care indicator corresponding to a vehicle care benefit;
the second range indicator of the plurality of indicators is an accident forgiveness indicator corresponding to an accident forgiveness benefit; and
the second level of safe driving behavior is higher than the first level of safe driving behavior.

10. The method of claim 1, wherein:
the one or more telemetry factors include at least one selected from a group consisting of braking, speeding, acceleration, and maneuvering; and
a driver performance metric associated with one of the one or more telemetry factors is a score indicative of an amount of at least one selected from a group consisting of braking, speeding, acceleration, and maneuvering within the time interval.

11. A computing device for presenting driver performance metrics, the computing device comprising:
a user interface;
one or more processors; and
a non-transitory computer-readable memory coupled to the user interface and the one or more processors, and storing thereon instructions that, when executed by the one or more processors, cause the computing device to:
determine one or more driver performance metrics for one or more telemetry factors based upon vehicle data of a user collected over a time interval;
generate a plurality of range indicators, wherein:
each range indicator of the plurality of range indicators represents a level of safe driving behaviors and is associated with a low score and a high score, the low score being greater than zero;
each range indicator of the plurality of range indicators corresponds to a type of benefit to the user;
the plurality of range indicators include a first range indicator and a second range indicator,
the first range indicator is associated with a first graphic and corresponds to a first type of benefits to the user and a first level of safe driving behavior;
the second range indicator is associated with a second graphic and corresponds to a second type of benefits to the user and a second level of safe driving behavior different from the first level of safe driving behavior; and
the first graphic is different from the second graphic; and
present, via the user interface, a driving summary display indicative of the one or more driver performance metrics for the one or more telemetry factors, the driving summary display including:
the plurality of range indicators, and
a performance indication for each driver performance metric of the one or more driver performance metrics, wherein the performance indication is presented within a corresponding range indicator of the plurality of range indicators for the corresponding telemetry factor, such that the user is made aware of which telemetry factor of the one or more telemetry factors needs to be improved upon;
wherein the first graphic and the second graphic each has a fill level corresponding to an amount remaining until the user reaches a respective level of safe driving behavior;
wherein the fill level increases of a corresponding graphic if one of the one or more driver performance metrics for a corresponding telemetry factor is within or above a range associated with the corresponding telemetry factor;
wherein the fill level of the corresponding graphic increases at a first speed if the one of the one or more driver performance metrics has a first score;
wherein the fill level of the corresponding graphic increases at a second speed if the one of the one or more driver performance metrics has a second score higher than the first score;
wherein the second speed is higher than the first speed.

12. (canceled)

13. The computing device of claim 11, wherein the instructions further cause the computing device to:
determine whether to provide a benefit corresponding to one of the plurality of range indicators based upon the performance indication associated with the one or more driver performance metrics and the associated plurality of range indicators.

14. The computing device of claim 13, wherein:
the user receives a corresponding benefit when the fill level meets or exceeds a threshold value.

15. (canceled)

16. The computing device of claim 11, wherein the first graphic is presented above the corresponding range of the driver performance metric associated with the first range indicator.

17. The computing device of claim 13, wherein the instructions that cause the computing device to determine whether to provide benefit corresponding to the one of the plurality of indicators further cause the computing device to:
assign a weight to each driver performance metric of the one or more driver performance metrics; and
determine whether to provide the benefit corresponding to the one of the plurality of range indicators based upon a weighted combination of the one or more driver performance metrics for the one or more telemetry factors.

18. The computing device of claim 13, wherein the instructions further cause the computing device to:
provide the benefit to the user based upon the determination.

19. The computing device of claim 11, wherein:
the first range indicator of the plurality of range indicators is a vehicle care indicator corresponding to a vehicle care benefit;
the second range indicator of the plurality of indicators is an accident forgiveness indicator corresponding to an accident forgiveness benefit; and
the second level of safe driving behavior is higher than the first level of safe driving behavior.

20. The computing device of claim 11, wherein:
the one or more telemetry factors include at least one selected from a group consisting of braking, speeding, acceleration, and maneuvering; and
a driver performance metric associated with one of the one or more telemetry factors is a score indicative of an amount of at least one selected from a group consisting of braking, speeding, acceleration, and maneuvering within the time interval.
